(19) United States
(12) Patent Application Publication
(10) Pub. No.: US 2004/0166353 A1
(43) Pub. Date: Aug. 26, 2004

(54) Wool-based textile of flame resistant character and articles formed therefrom

(76) Inventors: Jerry W. Owens JR., Boiling Springs, SC (US); John J. Burns, Simpsonville, SC (US)

Correspondence Address: James M. Robertson, Robertson & Mullinax, LLC, PO Box 26029, Greenville, SC, 29616-1029, US

(21) Appl. No.: 10/652,149

(22) Filed: Aug. 29, 2003

Related U.S. Application Data
(63) Continuation-in-part of application No. 10/452,514, filed on Jun. 2, 2003.
(60) Provisional application No. 60/407,228, filed on Aug. 29, 2002.

(51) Int. Cl. B32B 23/04

(52) U.S. Cl. 428/532; 442/320; 442/152

(57) ABSTRACT

Flame retardant textile structures which may be used alone or in combination with one or more covering layer to impart enhanced flame resistance in a wide array of applications. In particular, the textile structure incorporates a wool-based felt which contains about 60% by weight or greater of a mammal generated wool material.

### CROSS-REFERENCE TO RELATED APPLICANTIONS

This application claims benefit of U.S. Provisional Application 60/407,228 filed Aug. 29, 2002. This Application is a continuation-in-part of co-pending U.S. patent application Ser. No. 10/452,514 filed Jun. 2, 2003. The contents of all such applications are incorporated by reference herein in their entirety.

### TECHNICAL FIELD

This invention relates generally to a fibrous material of substantial flame resistance and more particularly to a material and end use applications therefor containing at least one layer of fibrous wool-based felted material containing a substantial percentage of mammal generated wool. Such wool-based material may be used alone or in combination with other layers to impart flame resistance to a wide array of products.

### BACKGROUND OF THE INVENTION

Textile structures of felted construction are well known. In such structures a mass of relatively short length staple fibers are formed into a cohesive structure by the entanglement of the fibers using a multiplicity of reciprocating needles which are passed back and forth through the fiber mass. As will be appreciated, by the term “staple fibers” is meant any natural or synthetic fiber structure of relatively short finite length as will be described further hereinafter. The needles may be of many shapes although barbed needles may be particularly preferred to facilitate entanglement.

In a number of environments it is desirable for textile components to have a degree of flame resistance. In the past, flame resistance has typically been achieved by use of synthetic flame retardant fiber constituents such as asbestos and the like and/or by application of chemical flame resisting agents. While such practices have permitted the production of products having a relatively high degree of flame resistance, the practices have been relatively complex and costly to carry out. Moreover, some of the fiber materials and chemical treatments may cause undesirable reactions in users.

Various testing procedures are used to evaluate the flammability characteristics of textile materials and articles formed therefrom. By way of example only, and not limitation, British Standard 5852 (incorporated herein by reference) describes test methods for assessing the ignitability of upholstered composites for seating covers and fillings when subjected to flaming sources of various thermal output ranges. More particularly, this standard test method utilizes a frame supporting segments of the material to be tested in an arrangement corresponding to the intersection between the seat and the back of a chair. A crib assembly formed from seasoned planks of softwood is constructed in a predefined manner including a layer of flammable lint and is thereafter ignited at an interior position on the seat in contact with the back. If flaming or progressive smoldering is not observed, the test is repeated at a different location. If flaming or progressive smoldering is still not observed, the material is considered to pass the test criteria. In this regard, any composite that produces externally detectable amounts of smoke, heat or glowing 60 minutes after ignition of the crib is considered to display progressive smoldering. Different crib constructions are utilized to mimic different levels of ignition. In the so called “crib 5” test the crib is formed from 10 layers (each of two sticks) for a total of 20 sticks wherein the sticks are 40±2 mm in length with a square section of 6.5 mm±0.5 mm. The total mass of sticks is 17 grams±1 gram. The approximate lint dimensions are 40 mm×40 mm.

Another flammability testing procedure which is used to evaluate resilient filling materials used in upholstered furniture is set forth in Technical Bulletin 117 (incorporated herein by reference) issued by the State Of California Department of Consumer Affairs Bureau of Home Furnishings and Thermal Insulation. In this test a specimen of predefined size is ignited by a flame in a vertical condition. The char length of the specimen and the time required for the specimen to self extinguish is thereafter measured and must meet predefined criteria in order to pass.

A similar testing procedure for evaluating flame resistance of materials to be used in automotive applications is set forth in Federal Motor Vehicle Safety Standard #302 (incorporated herein by reference) which will be well known to those of skill in the art and in which a flame is applied to a strip of material of predefined size and the rate and length of burning prior to self extinguishment is measured. Under this test, in order to pass the burn rate must be less than 4 inches/minute and the sample burn time prior to self extinguishing must be less than 60 seconds and the burn length must be less than 2 inches.

Still another testing procedure for measuring the flame resistance of a mattress and associated foundation (i.e. box spring) is set forth in Technical Bulletin 603 issued by the State of California Department of Consumer Affairs Bureau of Home Furnishings and Thermal Insulation the contents of which will be well known to those of skill in the art and which are hereby incorporated by reference as if fully set forth herein. In this testing procedure a pair of propane burners is utilized to mimic the heat flux levels and durations imposed on a mattress and foundation by burning bedclothes. These burners impose differing fluxes for differing times on the mattress top and on the sides of the mattress and any underlying foundation. The resulting smoke plume is captured and heat release levels are measured by oxygen consumption calorimetry using instrumentation as set forth in ASTM E 1590 (incorporated by reference). The test method also provides a measure of the emissions of carbon monoxide and carbon dioxide.

In the test of Technical Bulletin 603, propane gas from a source such as a bottle having a net heat of combustion of 46.5±0.5 MJ/kg (nominally 99% to 100% propane) is delivered through a multi-orifice stainless steel manifold burner having 34 openings (17 on each side of a T junction with the gas inlet) arranged to impact the top of the mattress. Propane is simultaneously delivered through a similar manifold burner having 28 openings (14 on each side of a T junction with the gas inlet) arranged to impact the sides the mattress/foundation. The openings in the burners are drilled using a #56 drill and are 1.17 mm to 1.22 mm in diameter. The gas flow rate to the top burner is 12.9±0.1 L/min at a pressure of 101±5 kPa (standard atmospheric pressure) and a temperature of 22±3 degrees Celsius corresponding to a flow rate of about 0.38 L/min per opening. The gas flow rate to the side burner is 6.6±0.5 L/min at a pressure of 101±5 kPa (standard atmospheric pressure) and a temperature of 22±3 degrees Celsius corresponding to a flow rate of about 0.24 L/min per opening. The duration of gas flow is 70 seconds for the top burner and 50 seconds for the side burner.

Under the testing criteria of Technical Bulletin 603 a mattress or a mattress/box spring set is considered to pass if the maximum rate of heat release is less than 150 kW and the total heat release is less than 25 MJ in the first 10 minutes of the test.

### SUMMARY OF THE INVENTION

The present invention provides advantages and alternatives over the prior art by providing a wool based material which may be used alone or in combination with a coating or covering to impart enhanced flame resistance in a wide array of applications so as to pass the relevant flame resistance standards as set forth above. In particular, the wool-based material incorporates a felted fibrous layer containing about 60% to 100% by weight of a mammal generated wool material. In this regard it is to be understood that by the term “mammal generated wool” is meant any virgin or recycled wool or mixture of virgin and recycled wool produced from mammals such as sheep, goats, llamas, alpacas and the like as well as mixtures of such wool from two or more different species. If desired, one or more functional or decorative covering layers may be applied across the wool based material. If used, such covering layers may be held in place by techniques such as needling, adhesive bonding, or combinations thereof. By way of example only, it is contemplated that such wool based material may be used in a wide range of applications including furniture upholstery; window blinds; mattress coverings, blankets and other bedding for adults and/or children; interior construction units such as office panels and the like; insulating internal linings and seals for heat generating appliances such as ovens, clothes dryers and the like; and in automotive upholstery and textile lining applications such as seat coverings, head linings, side panel linings, trunk linings and the like.

### BRIEF DESCRIPTION OF THE DRAWINGS

The following drawings which are incorporated in and which constitute a part of this specification illustrate several exemplary embodiments of the present invention and, together with the general description above and the detailed description set forth below, serve to explain the principles of the invention wherein:

FIGS. 1 and 2 illustrate schematically an exemplary process for formation of a wool-based fibrous felted material;

FIG. 3 is a schematic cross-section of an exemplary wool-based fibrous felted material;

FIG. 4 illustrates schematically an exemplary practice for application of an exterior adhesive layer across one side of a wool-based fibrous felted material;

FIG. 5 is a schematic cross-section of an adhesive covered precursor formed by the practice of FIG. 4;

FIG. 6 is a schematic cross-section of an exemplary multi-layer composite including an adhesive bonded decorative outer layer;

FIG. 7 is a view similar to FIG. 4, illustrating an exemplary practice for the application of adhesive layers across both sides of a wool-based fibrous felted material.

FIG. 8 is a view similar to FIG. 5, illustrating an adhesive covered precursor formed by the practice of FIG. 7;

FIG. 9 is a view similar to FIG. 6, illustrating an exemplary multi-layer composite including an adhesive bonded decorative outer layer on each side.

FIG. 10 illustrates a seating structure incorporating upholstery formed from a wool-based fibrous felted material;

FIG. 11 illustrates an exemplary window blind structure including slats incorporating wool-based fibrous felted material;

FIG. 12 illustrates a mattress including a covering incorporating wool-based fibrous felted material;

FIG. 13 illustrates an office panel incorporating wool-based fibrous felted material;

FIG. 14 is a cut-away schematic of a heat generating appliance incorporating a seal and insulating lining of wool-based fibrous felted material;

FIG. 15 illustrates a flame retardant suit incorporating clothing articles utilizing wool-based fibrous felted material; and

FIG. 16 is a cut-away view of an automotive transportation vehicle incorporating wool-based fibrous felted materials at various locations.

While the present invention has been illustrated and generally described above and will hereinafter be described in conjunction with certain potentially preferred embodiments, procedures, and practices, it is to be understood that in no case is the invention to be limited to such illustrated and described embodiments, procedures, and practices. On the contrary, it is intended that the present invention shall extend to all alternatives, modifications, and equivalents as may embrace the principles of the present invention within the true scope and spirit thereof.

### DESCRIPTION OF PREFERRED EMBODIMENTS

Reference will now be made to the various drawings wherein to the extent possible like reference numerals are utilized to designate corresponding components throughout the various views. As will be appreciated, for purposes of description various components are illustrated with enhanced dimensions and thus may not be in scale relative to one another.

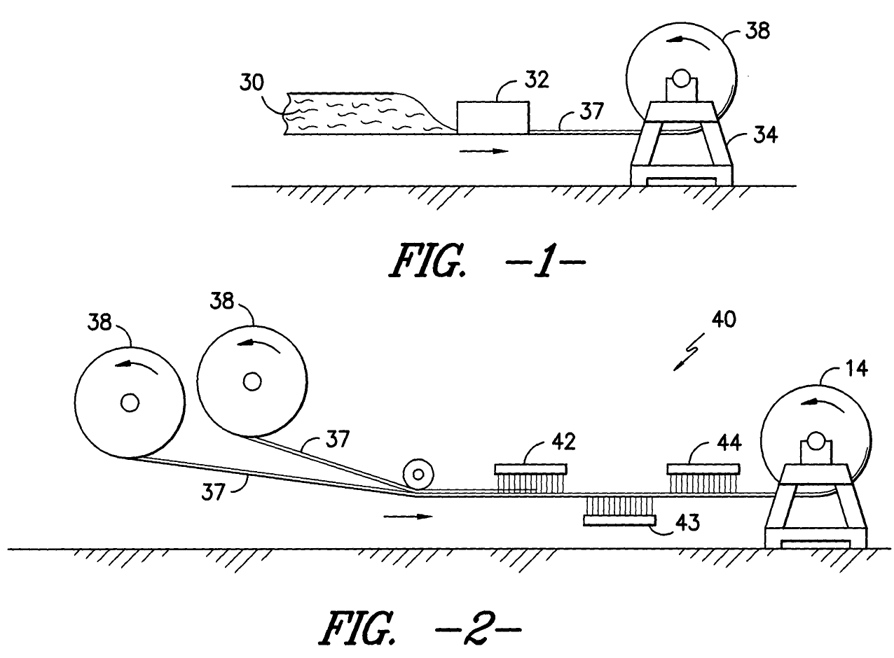

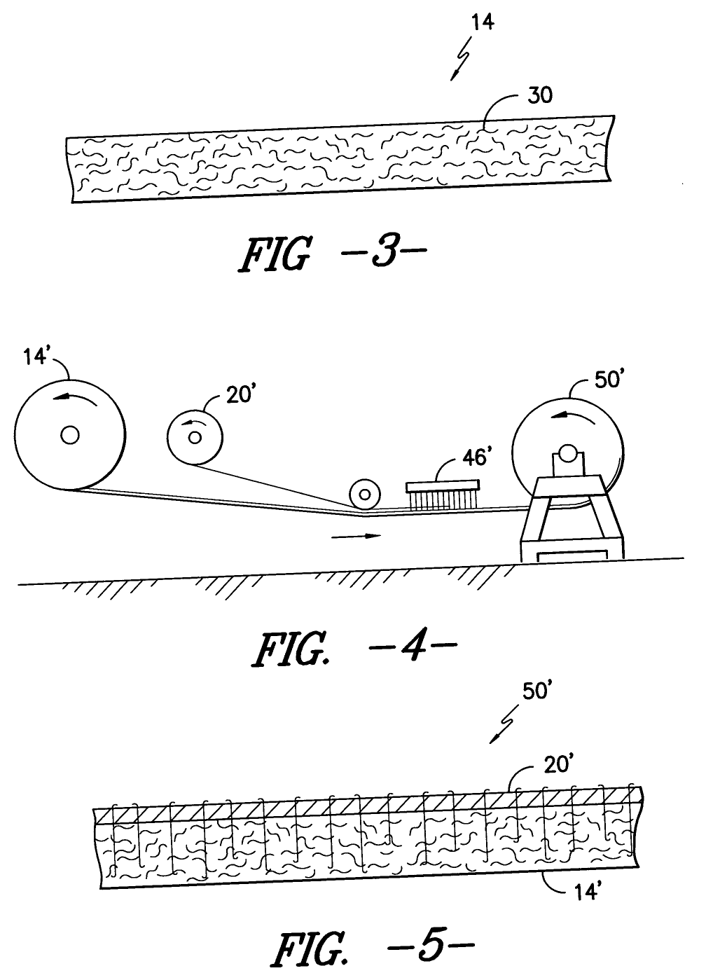

One exemplary practice for the production of a non-woven wool-based fibrous material of felted construction providing excellent flame resistance is illustrated schematically in FIGS. 1 and 2. According to the illustrated practice, a mass of discrete length fibers 30 including about 60% to 100% mammal generated wool fibers is passed through a carding unit 32 to yield a carded web material 37 which is taken up as a roll 38 on an “A” frame 34 or other collection device. The carded web material 37 is preferably a relatively light weight material having sufficient internal coherency to undergo further processing. While it is contemplated that the carded web material 37 will include at least 60% mammal generated wool, according to a potentially preferred practice, the carded web material 37 will include at least 80% mammal generated wool, and will most preferably include 90% to 100% mammal generated wool. The remainder of the fibers may be any suitable natural or synthetic material. By way of example only, and not limitation, such non-wool materials may include fibers of polyester, polypropylene, nylon, arimids (e.g. NOMEX®), glass, PBI (polybenzimidazole), KEVLAR®) and PAN (polyacrylonitrile) as well as blended combinations of such fibers. Such fibers are preferably in the form of relatively short length staple fibers which may be entangled with the wool fiber during a needling operation in a manner to be described further hereinafter.

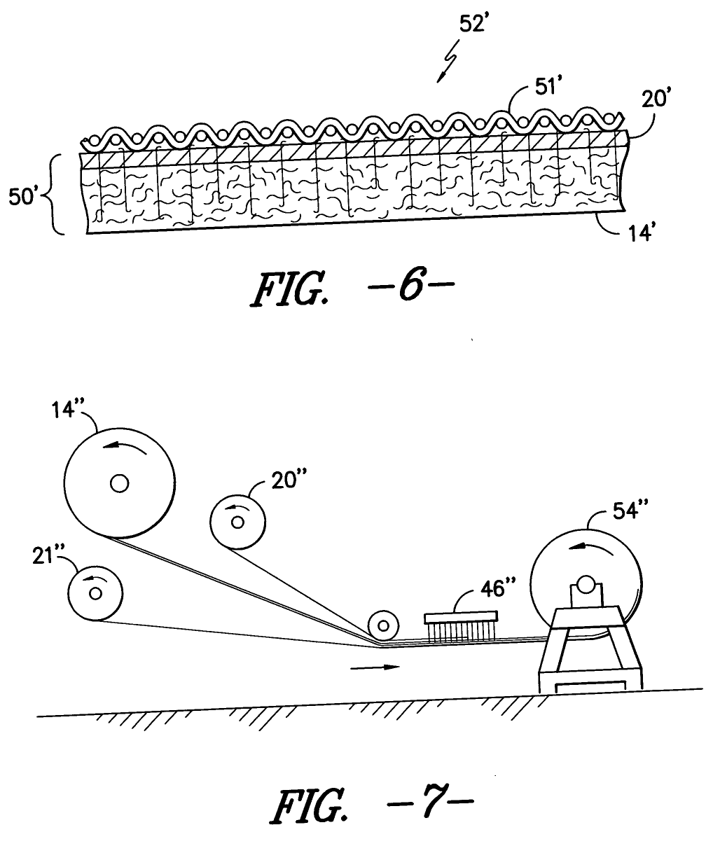

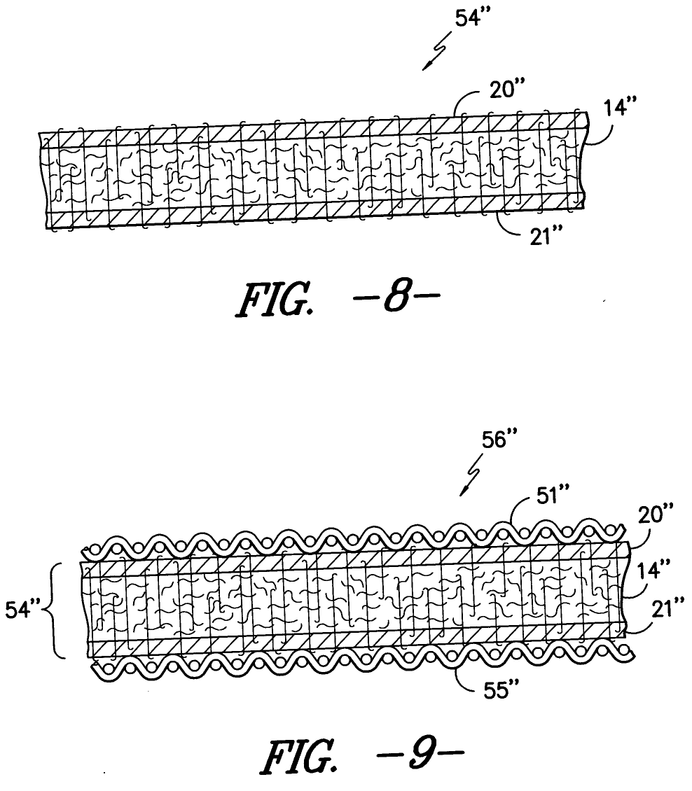

As illustrated in FIG. 2, following formation of the carded web material 37, the carded web material 37 may thereafter be conveyed through a combining and densification station 40. In the exemplary practice illustrated in FIG. 3, at the combining and densification station 40, the carded web material 37 is conveyed through a series of reciprocating needle looms 42, 43, 44 to form the carded web material into an enhanced density wool-based felt 14 (FIG. 3) which is taken up on a roll for further processing as will be described further hereinafter. Following the needling operation, the wool-based felt 14 which has about 60% to 100% mammal generated wool content preferably has a mass per unit area in the range of about 2 to about 120 ounces per square yard with a thickness of about 0.02 to about 1.0 inches. Of course, such ranges are exemplary only and other constructions may likewise be utilized if desired.

It is to be understood that the arrangement illustrated in FIG. 2 is exemplary and explanatory only. Thus, while two layers of carded web material 37 are illustrated as being combined at the combining and densification station 40, it is likewise contemplated that a single layer as well as three or more layers may be treated as may be desired. Likewise, while three reciprocating needle looms are shown, a larger or smaller number of needle looms (including a single needle loom) may be utilized if desired. Moreover, while double sided needling is illustrated and may be desirable in some applications, single sided needling using one or more needle looms may likewise be used. In one contemplated practice, needles in each of the needle looms 42, 43, 44 are of a barbed configuration being generally triangular in shape with a number of barbs disposed along each edge. Of course, other needle constructions may be used if desired.

As previously indicated, it is contemplated that the wool-based felt 14 may be used either alone or in combination with one or more covering layers to provide flame resistance in a number of applications. In particular, it is contemplated that the enhanced density wool-based felt 14 either alone or in combination with one or more covering layers such as woven or knit textiles will be suitable to pass the crib 5, Technical Bulletin 117 and FMVSS #302 flame resistance standards as outlined above. It is also contemplated that at increased thickness and/or with the addition of an intumescent or other flame repellent coating that flame resistance standards for mattress applications as outlined above may also be met.

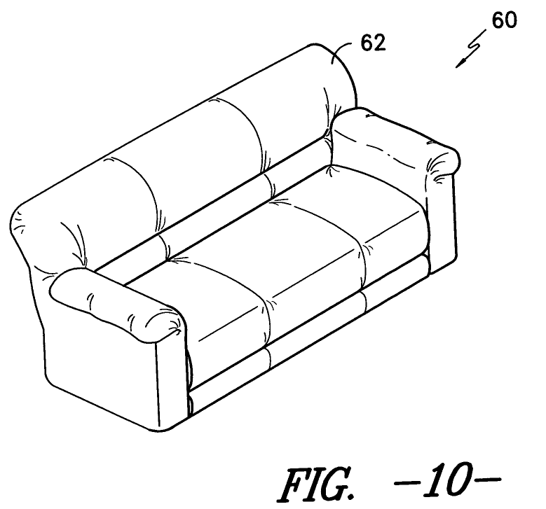

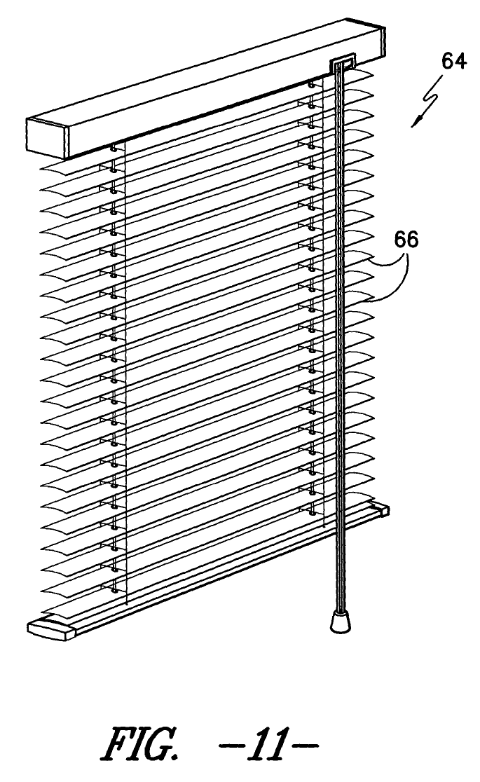

FIG. 4 illustrates one exemplary practice for the formation of an adhesive covered precursor 50′ wherein elements corresponding to those previously described are designated by like reference numerals with a prime. As shown, in this practice an adhesive layer 20′ is applied across one side of the wool-based felt 14′. According to one potentially preferred practice, the adhesive layer 20′ may be extremely light having a mass per unit area of less than about 2 ounces per square yard and more preferably about 0.2 to about 1 ounces per square yard. Of course, substantially heavier adhesive layers may be used if desired. It is contemplated that the adhesive layer 20′ may be formed from any wet or dry adhesive suitable to attach to a surface layer 51′ such as a woven, knit, nonwoven or pile textile or the like so as to form a composite material 52′ (FIG. 6) having a desired exterior.

According to one contemplated practice, the adhesive layer 20′ may be a dry adhesive in web form such as a polymer film, scrim, spunbonded fabric or the like which may be at least partially intermingled with the enhanced density wool-based felt 14′ by a needling loom 46′. In such a practice, the adhesive material is preferably of a nature such that it can be activated upon demand through application of a predetermined driving force such as heat, ultrasonic energy, radio frequency radiation waves and the like. Further, it is contemplated that the adhesive should provide necessary resistance to heat, humidity and chemical interaction so as to avoid any premature delamination. By way of example only, and not limitation, various suitable dry heat activated adhesives which may be used to form the adhesive layer 20′ are believed to be available as a spunbonded fabric webs under the trade designation SPUNFAB® adhesive fabric from Dry Adhesive Technologies Inc. having a place of business at Cuyahoga Falls, Ohio, USA. As will be appreciated, the use of such dry adhesives permits the adhesive covered precursor 50′ to be produced and thereafter secured across virtually any surface layer 51′ as may be desired at a later time.

Of course, other adhesive systems such as powders and wet adhesives may be used if desired. Moreover, it is also contemplated that the adhesive layer 20′ may be eliminated if desired by needling or otherwise securing the surface layer directly to the enhanced density wool-based felt.

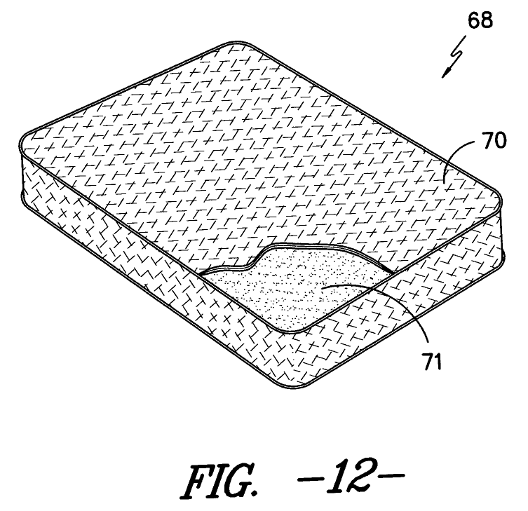

It is also contemplated that a precursor may be formed having adhesive layers applied across both sides of a wool-based felt. By way of example only, and not limitation, a process for the formation of such a precursor 54″ is illustrated in FIG. 7, wherein elements corresponding to those previously described are designated by like reference numerals with a double prime. As illustrated, this process is carried out in substantially the same manner as in FIG. 4, with the exception that a second layer of adhesive 21″ is applied across the underside of the wool-based felt 14″. In the illustrated practice both layers of adhesive are illustrated as dry webs as previously described partially intermingled with the wool-based felt. However, it is likewise contemplated that other adhesive structures may be used if desired. It is contemplated that either the same or different adhesives may be used across the top and bottom. As best illustrated in FIG. 9, a precursor 54″ with adhesive on both sides may be joined to a top surface layer 51″ as well as to a bottom surface layer 55″ to form a composite 56″ having surface coverings on both sides. Of course, one or both adhesive layers may be eliminated if desired.

Regardless of whether the enhanced density wool-based felt is used alone or as a component of a multilayer composite, it has been found that substantial resistance to flammability is achieved. It is thus contemplated that such materials may find application in a wide range of applications.

By way of example only, one important application for materials incorporating the wool-based felt is in furniture such as a seating unit 60 illustrated in FIG. 10. In such an application it is contemplated that the wool-based felt may form a part of the upholstery 62. In this regard, it is contemplated that the wool-based felt may be used either alone or as an interior layer with a decorative outer surface covering of textile or other material as previously described. In either event substantial flame resistance is provided such that the crib 5 and technical bulletin 117 standards are met.

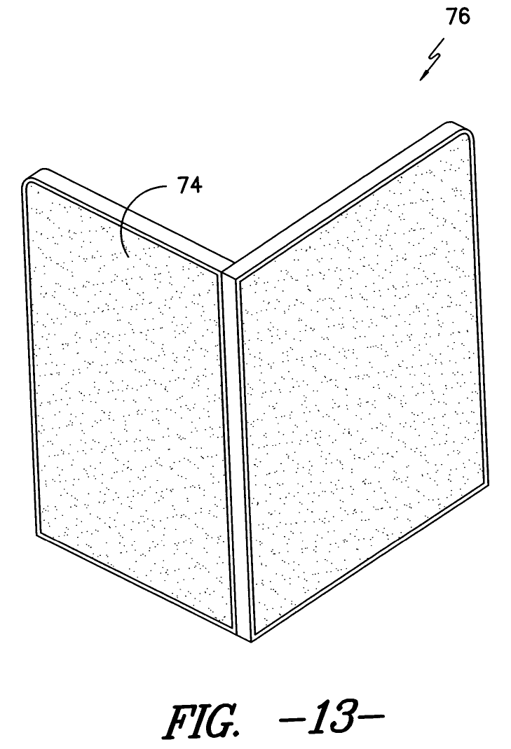

Another application for materials incorporating the wool-based felt is in blinds and other window coverings such as drapes and the like. By way of example only, an exemplary blind 64 incorporating an arrangement of adjustable slat elements 66 is shown in FIG. 11. It is contemplated that the slat elements 66 may incorporate the wool-based felt as a surface, backing or intermediate layer to aid in flame resistance. Such flame resistance permits use of the window coverings in applications such as hotels and the like in which standards are particularly rigorous. In addition, such flame resistance also permits use in transportation environments such as recreational vehicles and the like in which FMVSS #302 must be met.

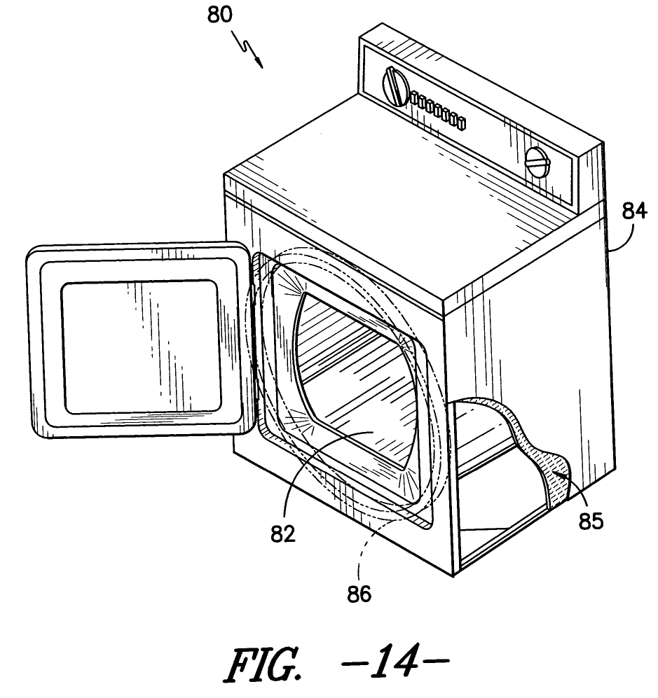

Another application for materials incorporating the wool-based felt is in coverings for mattresses and box springs. In FIG. 12, there is illustrated a mattress 68 having a covering 70 disposed over a core 71. As will be appreciated, the core 71 may be of any suitable construction including foam, spring structures, gas bladders, liquid bladders and the like including combinations of such elements as may be known to those of skill in the art. It is contemplated that such a covering may incorporate the wool-based felt used either alone or as an interior layer with a decorative outer surface covering of textile or other material as previously described. In either event substantial flame resistance is provided. Similar materials may also be used in covering a box spring unit supporting the mattress 68. It is also contemplated that the wool-based felt may be used either alone or in combination with surface layers of other material to form mattress pads, blanketing and other removable bedding articles.

Still another application for materials incorporating the wool-based felt is in interior structural articles such as office panels and wall elements used in forming modular office units. By way of example only, and not limitation, an exemplary office panel 76 having an interior structure 74 is illustrated in FIG. 13. It is contemplated that the wool based felt may be used alone or in combination with a decorative surface layer to form at least a portion of the interior structure 74. In such constructions it is believed that the wool-based felt may substantially aid in flame resistance.

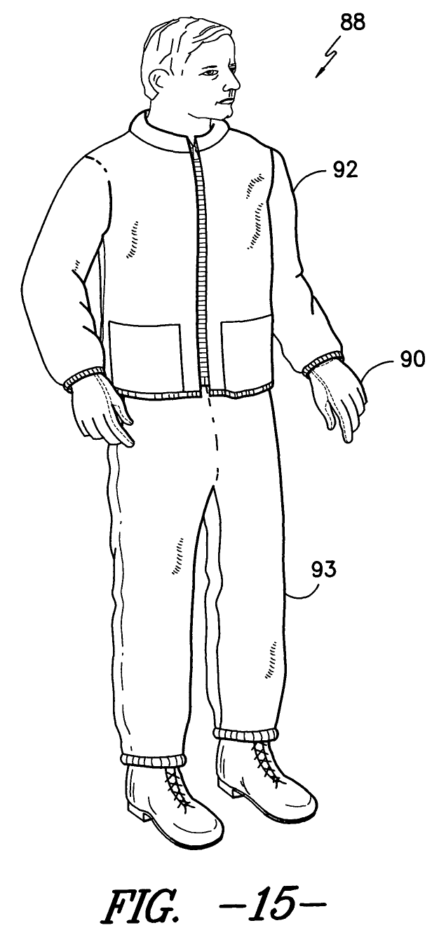

It is also contemplated that the wool-based felt may have application as a seal and/or insulating material in appliances such as stoves, dryers and the like. By way of example only and not limitation, in FIG. 14 there is illustrated a dryer 80 having an inner chamber 82 surrounded by a cabinet 84. A layer of insulating material 85 at least partially insulates the inner chamber and a ring shaped seal 86 is disposed at the end of the inner chamber to block undesired hot air leakage. It is contemplated that the wool-based felt may be used either along or in combination with additional layers to form the insulating material 85 and/or the seal. Substantial flame resistance is thus imparted to the appliance.

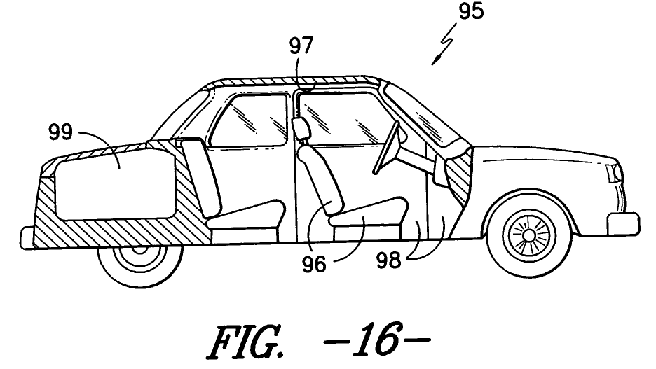

Another application for the wool-based felt is in protective clothing such as a fire-resistant suit 88 illustrated in FIG. 15. In such an application it is contemplated that gloves 90 and/or a jacket 92 and/or trousers 93 may incorporate wool based felt either alone or in combination with a desired surface layer to provide flame protection.

Still another application for the wool-based felt is in automobiles. By way of example only, and not limitation, FIG. 16 illustrates an automobile 95 having multiple zones in which the wool-based felt may be used alone or in combination with one or more additional layers as previously described. In particular, it is contemplated that the wool-based felt may be used alone or in combination with layers of other material to form upholstery 96 for seats within the vehicle. It is also contemplated that the wool-based felt may be used alone or in combination with layers of other material to form a head lining 97, side panel covering 98 or trunk lining 99. It is believed that the flame resistivity of the wool-based felt may aid in meeting the requirements of FMVSS #302 even if additional decorative layers or adhesives are utilized which may otherwise make passage difficult.

While the present invention has been illustrated and described in relation to certain potentially preferred embodiments and practices, it is to be understood that such embodiments and practices are illustrative and exemplary only and that the present invention is in no event to be limited thereto. Rather, it is contemplated that modifications and variations to the present invention will no doubt occur to those of skill in the art upon reading the above description and/or through a practice of the invention. It is therefore contemplated and intended that the present invention shall extend to all such modifications and variations which incorporate the broad principles of the present invention within the full spirit and scope thereof.

1. A flame retardant textile article selected from the group consisting of furniture upholstery, window blinds, mattress coverings, modular panels, appliance seals; appliance insulation; clothing; automotive upholstery; automotive head linings; automotive interior side panel coverings and automotive trunk linings, wherein the flame retardant textile article comprises at least one layer of wool-based felt comprising about 60% to 100% by weight mammal generated wool, and wherein the flame retardant textile is characterized by a level of flame resistance such that it passes at least one of the British Standard 5852 crib 5, Technical Bulletin 117 or Federal Motor Vehicle Safety Standard 302 flammability tests.

2. The invention as recited in claim 1, wherein the wool-based felt comprises about 80% by weight or more of mammal generated wool fiber.

3. The invention as recited in claim 1, wherein the wool-based felt comprises about 90% by weight or more of mammal generated wool fiber.

4. The invention as recited in claim 1, wherein the wool-based based felt comprises about of 100% by weight of mammal generated wool fiber.

5. The invention as recited in claim 1, wherein the clothing comprises a flame retardant jacket.

6. The invention as recited in claim 1, wherein the clothing comprises flame retardant gloves.

7. The invention as recited in claim 1, wherein the clothing comprises flame retardant trousers.

8. The invention as recited in claim 1, further comprising a non-wool surface fabric disposed across at least one side of the wool-based felt.

9. The invention as recited in claim 8, wherein the wool-based felt comprises about 90% by weight or more of mammal generated wool fiber.

10. The invention as recited in claim 8, wherein the wool-based based felt comprises about 100% by weight of mammal generated wool fiber.

11. A flame retardant textile composite structure comprising:
a decorative surface fabric;
at least one layer of wool-based felt comprising about 60% to 100% by weight mammal generated wool fiber; and
a layer of resilient heat activated polymeric adhesive disposed between the decorative surface fabric and the layer of wool based felt, wherein the flame retardant textile composite is characterized by a level of flame resistance such that it passes at least one of the British Standard 5852 crib 5, Technical Bulletin 117 or Federal Motor Vehicle Safety Standard 302 flammability tests.

12. The invention as recited in claim 11, wherein the layer of wool-based felt comprises about 80% by weight or more of mammal generated wool fiber.

13. The invention as recited in claim 11, wherein the layer of wool-based felt comprises about 90% by weight or more of mammal generated wool fiber.

14. The invention as recited in claim 11, wherein the layer of wool-based felt comprises about of 100% by weight of mammal generated wool fiber.

15. A flame retardant textile composite structure comprising:
at least one layer of wool-based felt comprising about 60% to 100% by weight mammal generated wool fiber disposed between two exterior surface layers of textile material; and
bonding layers of resilient heat activated polymeric adhesive disposed in bonding relation between the wool-based felt and the exterior surface layers, wherein the flame retardant textile composite is characterized by a level of flame resistance such that it passes at least one of the British Standard 5852 crib 5, Technical Bulletin 117 or Federal Motor Vehicle Safety Standard 302 flammability tests.

16. The invention as recited in claim 15, wherein the layer of wool-based felt comprises about 80% by weight or more of mammal generated wool fiber.

17. The invention as recited in claim 15, wherein the layer of wool-based felt comprises about 90% by weight or more of mammal generated wool fiber.

18. The invention as recited in claim 15, wherein the layer of wool-based felt comprises about of 100% by weight of mammal generated wool fiber.
